(19) United States
(12) Patent Application Publication
(10) Pub. No.: US 2018/0156996 A1
(43) Pub. Date: Jun. 7, 2018

(54) OPTICAL FIBER AND OPTICAL FIBER RIBBON

(71) Applicant: SUMITOMO ELECTRIC INDUSTRIES, LTD., Osaka-shi, Osaka (JP)

(72) Inventors: Noriaki IWAGUCHI, Yokohama-shi, Kanagawa (JP); Masuo IIDA, Osaka-shi, Osaka (JP); Takashi FUJII, Yokohama-shi, Kanagawa (JP)

(73) Assignee: SUMITOMO ELECTRIC INDUSTRIES, LTD., Osaka-shi, Osaka (JP)

(21) Appl. No.: 15/575,469

(22) PCT Filed: Jan. 6, 2017
(86) PCT No.: PCT/JP2017/000258

§ 371 Date: Nov. 20, 2017

(30) Foreign Application Priority Data
Jan. 12, 2016 (JP) 2016-003716

(51) Int. Cl. G02B 6/44; G02B 6/02; B32B 17/02; B32B 7/02; C03C 25/24

(52) U.S. Cl. CPC G02B 6/4403; G02B 6/02; G02B 6/448; B32B 7/02; C03C 25/24; B32B 17/02

(57) ABSTRACT

An optical fiber according to an embodiment of the present invention comprises a glass fiber having a core and a cladding covering the core, and a coating resin layer covering the glass fiber, wherein when the adhesion between the glass fiber and the coating resin layer at 85° C. is defined as x and the elastic modulus of the coating resin layer at 85° C. and at a frequency of 11 Hz is defined as y, the x is 0.2 to 0.6 kgf, the y is 600 to 6000 MPa, and the x and the y satisfy a relationship represented by y >222.1e^{4.7799x}.

### TECHNICAL FIELD

The present invention relates to an optical fiber and an optical fiber ribbon.

The present application claims the priority of Japanese Patent Application No. 2016-003716, filed on Jan. 12, 2016. The Japanese Patent Application is herein incorporated in its entirety.

### BACKGROUND ART

An optical fiber generally has a coating resin layer for protecting a glass fiber. Optical fibers may be used in the form of optical fiber ribbons in which a plurality of optical fibers are placed parallel and covered with a ribbon material. When an optical fiber ribbon is connected, a portion of a ribbon material needs to be stripped from glass fibers together with a coating resin layer. When the ribbon material is stripped from the glass fiber together with the coating resin layer, a portion of the coating resin layer may remain around the glass fiber.

To solve this problem, Patent Literature 1 discloses an optical fiber ribbon in which the difference amount between the glass transition temperatures of coating materials covering a glass fiber is adjusted.

### CITATION LIST

### Patent Literature

Patent Literature 1: Japanese Patent No. 5237107

### SUMMARY OF INVENTION

An optical fiber according to an embodiment of the present invention comprises a glass fiber having a core and a cladding covering the core, and a coating resin layer covering the glass fiber, wherein when the adhesion between the glass fiber and the coating resin layer at 85° C. is defined as x and the elastic modulus of the coating resin layer at 100° C. and at a frequency of 11 Hz is defined as y, the x is 0.2 to 0.6 kgf, the y is 600 to 6000 MPa, and the x and the y satisfy a relationship represented by the following expression (I):

y>222.1e^{4.7799x} (I)

### BRIEF DESCRIPTION OF DRAWINGS

FIG. 1 is a cross section showing an example of an optical fiber according to the embodiment.

FIG. 2 is a cross section showing an example of an optical fiber ribbon according to the embodiment.

FIG. 3 is a graph on which the relationship between the adhesion between a glass fiber and a coating resin layer, and the elastic modulus of a coating resin layer is plotted.

### DESCRIPTION OF EMBODIMENTS

### Technical Problem

In order to improve the lateral pressure characteristics of an optical fiber, a coating resin layer with low Young's modulus is required to be formed on the side contacting a glass fiber. However, since as the Young's modulus of the coating resin layer becomes lower, the tensile strength becomes also lower, coating leavings come to remain on the glass fiber side easily when a ribbon matrix is stripped together with the coating resin layer.

Accordingly, an object of the present disclosure is to provide an optical fiber and an optical fiber ribbon having excellent simultaneous ribbon stripability.

### Advantageous Effect of the Present Disclosure

According to the present disclosure, an optical fiber and an optical fiber ribbon having excellent simultaneous ribbon stripability can be provided.

### Description of Embodiments according to the Present Invention

First, the contents of the embodiments according to the present invention will be enumerated and described. An optical fiber according to an embodiment of the present invention comprises a glass fiber and a coating resin layer covering the glass fiber, wherein when the adhesion between the glass fiber and the coating resin layer at 100° C. is defined as x and the elastic modulus of the coating resin layer at 85° C. and at a frequency of 11 Hz is defined as y, the x is 0.2 to 0.6 kgf, the y is 600 to 6000 MPa, and the x and the y satisfy a relationship represented by the following formula (I):

y>222.1e^{4.7799x} (I)

The present inventors have found that there is a correlation between the force applied when a coating resin layer is pulled out from an optical fiber (pull-out force) and the elastic modulus of a coating resin layer, and completed the present invention. By satisfying a specific relationship of the adhesion between a glass fiber and a coating resin layer, and the elastic modulus of a coating resin layer, optical fibers according to the embodiments will have excellent simultaneous ribbon stripability for removing a portion of the ribbon material from glass fibers together with the coating resin layer when optical fibers are used in the form of an optical fiber ribbon.

In view of the multi-coreization of an optical cable, the outer diameter of the optical fiber may be 190 to 260 μm, and may be 190 to 210 μm. The outer diameter of an optical fiber is generally 250 μm, but the outer diameter of the optical fiber may be less than 250 μm.

When a coating resin layer is composed of a plurality of layers and the outermost layer of the coating resin layer is a colored layer, the outer diameter of the colored optical fiber may be 260 μm or less. In view of the multi-coreization of an optical cable, the outer diameter of a colored optical fiber may be 210 μmn or less. Since a certain thickness is necessary for a coating resin layer in order to impart mechanical strength to an optical fiber, it is desirable that the outer diameter of the colored optical fiber is 185 μm or more.

In an optical fiber of the embodiment, the coating resin layer has a primary resin layer and a secondary resin layer, and the primary resin layer may comprise a cured product of a ultraviolet curable resin composition containing a polyfunctional monomer. This improves the balance between the tensile strength and the Young's modulus of the primary resin layer. When the coating resin layer is stripped from a glass fiber, coating leavings hardly remain.

The ultraviolet curable resin composition may further contain a silane coupling agent. This facilitates adjusting the adhesion between the glass fiber and the primary resin layer.

An optical fiber ribbon according to an embodiment of the present invention is formed in which the plurality of optical fibers are placed parallel and covered with a ribbon material. Since the optical fibers according to the embodiment are used, the optical fiber ribbon has excellent simultaneous ribbon stripability when connected.

The glass transition temperature of the ribbon material may be 60° C. or more. Therefore, the optical fiber ribbon has still more excellent simultaneous ribbon stripability.

### DETAILED DESCRIPTION OF EMBODIMENTS ACCORDING TO THE PRESENT INVENTION

Optical fibers according to the embodiments of the present invention and specific examples of the manufacturing method thereof will be described hereinafter with reference to drawings. The present invention is not limited to these exemplifications, but shown by claims, and intended to include all modifications within the scope of claims and equivalence and in the meaning of equivalence. In the following description, the same components in the description of drawings are indicated with the same sign to omit overlapping description.

(Fiber)

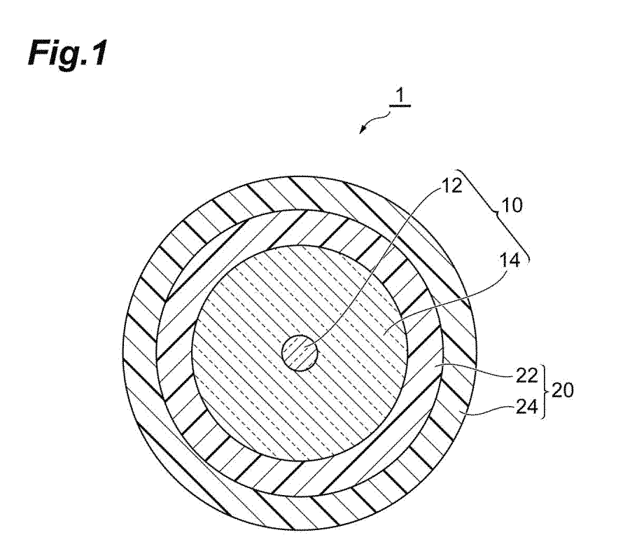

FIG. 1 is a cross section showing an example of an optical fiber 1 according to the embodiment. As shown in FIG. 1, the optical fiber 1 according to the embodiment comprises a glass fiber 10 that is an optical transmission medium, and a coating resin layer 20.

The glass fiber 10 has a core 12 and a cladding 14, and consists of a glass member, for example SiO₂ glass. The glass fiber 10 transmits light introduced into an optical fiber 1. The core 12, for example, is provided in a region including the center axial line of the glass fiber 10. The core 12 may be pure SiO₂ glass or SiO₂ containing GeO₂ or a fluorine element. The cladding 14 is provided in the region around the core 12. The cladding 14 has a lower refractive index than the core 12. The cladding 14 may consist of pure SiO₂ glass or SiO₂ glass to which a fluorine element is added.

The diameter of the glass fiber 10 is generally around 125 μm. It is preferable that the total thickness of the coating resin layer 20 is 32.5 to 67.5 μm, and the total thickness of the coating resin layer 20 may be 32.5 to 42.5 μm. It is preferable that the outer diameter of the optical fiber 1 is 190 to 260 μm, and the outer diameter of the optical fiber 1 may be 190 to 210 μm.

The coating resin layer 20 is composed of a plurality of layers, and has at least a primary resin layer 22 that is the first layer in contact with the glass fiber, and a secondary resin layer 24 that is the second layer in contact with the first layer. For example, when the coating resin layer 20 consists of two layers, as shown in FIG. 1, the coating resin layer 20 is composed of a primary resin layer 22 that is the first layer, and a secondary resin layer 24 that is the second layer.

It is preferable that the Young's modulus of the primary resin layer 22 is 1.0 MPa or less at 23° C., more preferably 0.8 MPa or less, still more preferably 0.7 MPa or less. The minimum value of the Young's modulus of the primary resin layer 22 is not particularly limited, but is around 0.1 MPa.

The adhesion between the glass fiber 10 and the coating resin layer 20 at 100° C. (x) is 0.2 to 0.6 kgf, preferably 0.3 to 0.5 kgf. The elastic modulus of the coating resin layer at 85° C. at a frequency of 11 Hz (y) is 600 to 6000 MPa, preferably 700 to 5600 MPa.

In the optical fiber according to the embodiment, the x and the y satisfy a relationship represented by the following formula (I):

y>222.1e^{4.7799x} (I)

Methods used for manufacturing optical fibers conventionally may be applied as methods for forming the coating resin layer 20 on the glass fiber 10.

For example, a process in which a resin composition for forming a primary resin layer is applied around the cladding 14 and cured by ultraviolet irradiation to form the primary resin layer 22, and thereafter, a resin composition for forming a secondary resin layer is applied around the primary resin layer 22 and cured by ultraviolet irradiation to form the secondary resin layer 24 (wet-on-dry process) may be used. A process in which a resin composition for forming a primary resin layer is applied around the cladding 14, and thereafter, a resin composition for forming a secondary resin layer is applied around the resin composition for forming a primary resin layer, and the resin compositions are cured by ultraviolet irradiation at the same time to form the primary resin layer 22 and the secondary resin layer 24 (wet-on-wet process) may be used.

A colored layer, which serves as an ink layer, may be formed around the secondary resin layer 24 constituting the coating resin layer 20 to identify optical fibers. The secondary resin layer 24 may be colored to be a colored layer (hereinafter, called “colored secondary resin layer”). Namely, when the outermost layer of the coating resin layer 20 is a colored layer (an optical fiber is an optical fiber having an ink layer or a colored secondary resin layer), the optical fiber is a colored optical fiber.

In view of manufacturing a high density optical fiber cable, the outer diameter of a colored optical fiber may be 210 μm or less. Since a certain thickness is necessary for a coating resin layer 20 in order to impart mechanical strength to an optical fiber, it is desirable that the outer diameter of a colored optical fiber is 185 μm or more. When an optical fiber has an ink layer, it is desirable that the outer diameter of the optical fiber except the ink layer is 200 μm or less, desirably 180 μm or more.

It is preferable that a colored layer contains a pigment in view of improvement in ease of identification of optical fibers. Examples of pigments include color pigments such as carbon black, titanium oxide and zinc flower; magnetic powders such as γ-Fe₂O₃, mixed crystals of γ-Fe₂O₃ and γ-Fe₃O₄, CrO₂, cobalt ferrite, cobalt-adsorbed iron oxide, barium ferrite, Fe—Co and Fe—Co—Ni; inorganic pigments such as MIO, zinc chromate, strontium chromate, aluminium tripolyphosphate, zinc, alumina, glass and mica; organic pigments such as azo-based pigments, phthalocyanine-based pigments, and dyeing lake pigments. Treatments such as various surface modifications and follnation of a composite pigment may be performed on pigments.

The coating resin layer 20, for example, can be formed by curing an ultraviolet curable resin composition comprising an oligomer, a monomer and a photopolymerization initiator.

Examples of oligomers include urethane (meth)acrylates. Two or more oligomers may be mixed and used. Here, a (meth)acrylate means an acrylate or a methacrylate corresponding thereto. Much the same is true on (meth)acrylic acid.

Examples of urethane (meth)acrylates include a product formed by reacting a polyol compound, a polyisocyanate compound and a hydroxyl group-containing acrylate compound. Examples of polyol compounds include polytetramethylene glycol, polypropylene glycol, and bisphenol A-ethylene oxide adduct diol. Polyisocyanate compounds include 2,4-tolylene diisocyanate, 2,6-tolylene diisocyanate, and isophorone diisocyanate. Examples of hydroxyl group-containing acrylate compounds include 2-hydroxymethyl (meth)acrylate, 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol di(meth)acrylate.

As a monomer, a monofunctional monomer having one polymerizable group or a polyfunctional monomer having two or more polymerizable groups can be used. Two or more monomers may be mixed and used.

Examples of monofunctional monomers include N-vinyl monomers having a cyclic structures such as N-vinyl pyrrolidone, N-vinyl caprolactam, and (meth)acryloyl morpholine; and (meth)acrylate compounds such as isobornyl (meth)acrylate, tricyclodecanyl (meth)acrylate, benzyl (meth)acrylate, dicyclopentanyl (meth)acrylate, 2-hydroxyethyl (meth)acrylate, nonylphenyl (meth)acrylate, phenoxyethyl (meth)acrylate, and polypropylene glycol mono(meth)acrylate. Particularly, N-vinyl monomers having cyclic structures are preferable in respect of improvement in the cure rate.

Examples of polyfunctional monomers include polyethylene glycol di(meth)acrylate, tricyclodecanediyldimethylene di(meth)acrylate, tripropylene glycol di(meth)acrylate, hexanediol di(meth)acrylate, trimethylol propane tri(meth)acrylate, ethylene oxide or propylene oxide adduct diol di(meth)acrylate of bisphenol compounds, and epoxy (meth)acrylate obtained by adding di(meth)acrylate to the glycidyl ether of a bisphenol compound.

Examples of bisphenol compounds include bisphenol A, bisphenol AP, bisphenol B, bisphenol BP, bisphenol C, and bisphenol E, and particularly, bisphenol A is preferable. Namely, polyfunctional monomers having bisphenol skeletons can be used as polyfunctional monomers, and it is particularly preferable that polyfunctional monomers having bisphenol A skeletons are used.

By adding a polyfunctional monomer to a resin composition for forming a primary resin layer, the balance between the tensile strength and the Young's modulus of a primary resin layer is improved, and coating leavings come to hardly remain when a coating resin layer is stripped from a glass fiber.

A photopolymerization initiator can be suitably selected from known radical photopolymerization initiators and used, and examples of photopolymerization initiators include acyl phosphine oxide-based initiators and acetophenone-based initiators. Two or more photopolymerization initiators may be mixed and used.

Examples of acyl phosphine oxide-based initiators include 2,4,6-trimethylbenzoyl diphenylphosphine oxide (from BASF Japan Ltd., trade name; “Lucirin TPO”), 2,4,4-trimethyl pentylphosphine oxide, and 2,4,4-trimethylbenzoyl diphenyl phosphine oxide.

Examples of acetophenone-based initiators include 1-hydroxycyclohexan-1-yl phenyl ketone (from BASF Japan Ltd., trade name; “Irgacure 184”), 2-hydroxy-2-methyl-1-phenyl-propan-1-one (from BASF Japan Ltd., trade name; “Darocur 1173”), 2,2-dimethoxy-1,2-diphenylethan-1-one (from BASF Japan Ltd., trade name; “Irgacure 651”), 2 -methyl-1-(4-methylthiophenyl)-2-morpholinopropan-1-one (from BASF Japan Ltd., trade name; “Irgacure 907”), 2-benzyl-2-dimethylamino-1-(4-morpholinophenyl)-butanone-1 (from BASF Japan Ltd., trade name; “Irgacure 369”), 1 -hydroxycyclohexylphenylketone, 2,2-dirnethoxy-2-phenylacetophenone, and 1-(4-isopropylphenyl)-2-hydroxy-2-methylpropan-1-one.

A silane coupling agent may be blended in an ultraviolet curable resin composition. Particularly when a resin composition forming a primary resin layer comprises a silane coupling agent, it becomes easy to adjust the adhesion between a glass fiber and a primary resin layer. Examples of silane coupling agents include silane coupling agents represented by the following formula (1) and (2). Two or more silane coupling agents may be mixed and used.

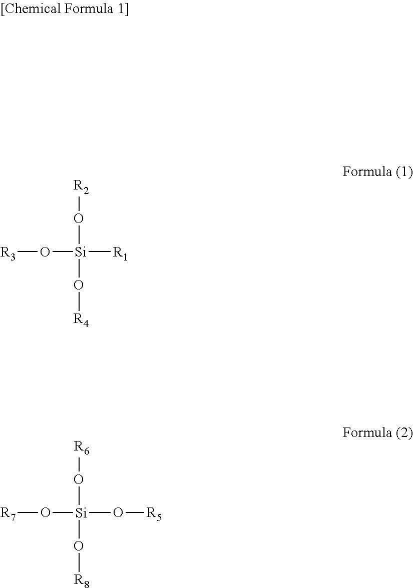

In Formulae (1) and (2), R1 represents a UV irradiation reactive group, and R2 to R8 each independently represent alkyl groups having 1 to 4 carbon atoms.

Examples of UV irradiation reactive groups in R1 in Formula (1) include groups having functional groups such as mercapto, vinyl, allyl, and (meth)acryloyl.

R2 to R8 in Formula (1) and (2) may each be the same or different, and are not particularly limited as long as R2 to R8 are alkyl groups having one or more carbon atoms. However, it is preferable that R2 to R8 have four or less carbon atoms. R2 to R8 specifically include methyl, ethyl, propyl and butyl group.

Examples of the silane coupling agent represented by Formula (1) include 3-mercaptopropyltrimethoxysilane, 3-mercaptopropyltriethoxysilane, 3-mere aptopropyltripropoxy silane, allyltrimethoxysilane, allyltriethoxysilane, allyltripropoxysilane, vinyltrimethoxysilane, vinyltriethoxysilane, vinyltripropoxysilane, 3-(meth)acryloxypropyltrimethoxysilane, and 3-(meth)acryloxypropyltriethoxysilane. Examples of silane coupling agents represented by Formula (2) include tetramethoxysilane, tetraethoxysilane and tetrapropoxysilane.

It is preferable that the content of a silane coupling agent is 0.2 to 2 mass % on the basis of the total amount of a resin composition for forming a primary resin layer.

(Optical Fiber Ribbon)

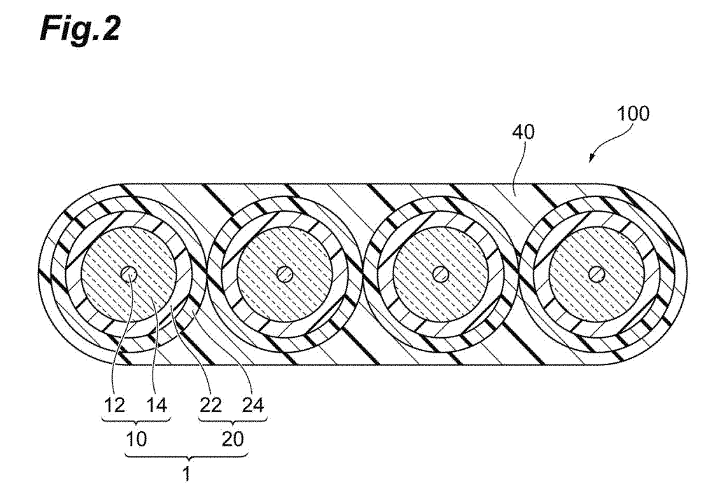

An optical fiber ribbon can be produced by using optical fibers of the embodiment. FIG. 2 is the cross section of an optical fiber ribbon 100 according to the embodiment. The optical fiber ribbon 100 shown in the same figure is an optical fiber ribbon in which a plurality of optical fibers 1 (four optical fibers in this case) are placed parallel and integrated by a ribbon material 40. As to an optical fiber ribbon of the embodiment, a ribbon material is stripped together with a coating resin layer from the optical fiber ribbon, and a glass fiber can be exposed.

An ribbon material 40 is, for example, formed from an epoxy acrylate resin, a urethane acrylate resin and the like. It is preferable that the glass transition temperature of a ribbon material is 60° C. or more, preferably 70 to 105° C. in view of ease of ribbon material removal.

### EXAMPLES

Then, the present invention will be described in detail by way of Examples, but is not limited to these Examples.

[Preparation of a Resin Composition for Forming a Primary Resin Layer]

A urethane acrylate obtained by reacting a diisocyanate and hydroxyethyl acrylate with polypropylene glycol diol, nonylphenyl acrylate, N-vinylcaprolactam, tripropylene glycol diacrylate, 2,4,6-trimethylbenzoyl diphenylphosphine oxide (from BASF Japan Ltd., trade name; “Lucirin TPO”), and mercaptopropyltrimethoxysilane which is a silane coupling agent, were mixed, and various resin compositions for forming primary resin layers were prepared with altered content ratios of each component.

[Preparation of a Resin Composition for Forming a Secondary Resin Layer]

A urethane acrylate obtained by reacting a diisocyanate and hydroxyethyl acrylate with polypropylene glycol diol, a bisphenol-based epoxy acrylate, isobornyl acrylate, N-vinylcaprolactam, and TPO were mixed, and various resin compositions for forming secondary resin layers were prepared with altered content ratios of each component.

[Preparation of a Resin composition for Forming a Colored Layer]

Then, 70 parts by mass of a urethane acrylate-based resin, 6 parts by mass of an organic pigment, 20 parts by mass of a mixture of a difunctional acrylate monomer and a polyfunctional acrylate monomer (blending ratio: 4/6), 3 parts by mass of Irgacure 907, 0.03 parts by mass of a phenol-based antioxidant, 0.01 parts by mass of a sulfur-based antioxidant, 0.01 parts by mass of an amine-based polymerization inhibitor and 0.1 parts by mass of silicone oil were mixed, and a resin composition for forming a colored layer (ink layer) was prepared.

[Preparation of a Resin Composition for Forming a Colored Secondary Resin Layer]

With 100 parts by mass of a resin composition for forming a secondary resin layer used in Example 1, 5 parts by mass of an organic pigment was mixed, and a resin composition for forming a colored secondary resin layer was prepared.

[Preparation of a Resin Composition for a Ribbon Material]

Then, 18 parts by mass of a urethane acrylate obtained by reacting 1 mol of bisphenol A-ethylene oxide adduct diol, 2 mol of tolylene diisocyanate and 2 mol of hydroxyethyl acrylate; 10 parts by mass of a urethane acrylate obtained by reacting 1 mol of polytetramethylene glycol, 2 mol of tolylene diisocyanate and 2 mol of hydroxyethyl acrylate; 15 parts by mass of tricyclodecane diacrylate obtained by reacting 1 mol of tolylene diisocyanate and 2 mol of hydroxyethyl acrylate; 10 parts by mass of N-vinyl pyrrolidone; 10 parts by mass of isobomyl acrylate; 5 parts by mass of bisphenol A-ethylene oxide adduct diol diacrylate; 0.7 parts by mass of 2-methyl-1[4-(methylthio)phenyl]-2-morpholino-propan-l-one (from BASF Japan Ltd., trade name; “Irgacure 907”); and 1.3 parts by mass of TPO were mixed, and a resin composition for a ribbon material was prepared.

[Optical Fiber]

### Examples 1 to 4 and Comparative Examples 1 to 6

Optical fibers having an outer diameter of 260 μm were produced, respectively, by forming primary resin layers around glass fibers composed of cores and claddings and having a diameter of 125 μm so that the primary resin layers had an outer diameter of 190 μm, forming secondary resin layers around the primary resin layers so that the secondary resin layers had an outer diameter of 250 μm, and further forming colored layers (ink layers) around the secondary resin layers.

### Example 5

An optical fiber having an outer diameter of 200 μm was produced by forming a primary resin layer used in Example 1 around a glass fiber composed of a core and a cladding and having a diameter of 125 μm so that the primary resin layer had an outer diameter of 160 μm, forming a secondary resin layer used in Example 1 around the primary resin layer so that the secondary resin layer had an outer diameter of 195 μm, and further forming a colored layer (ink layer) around the secondary resin layer.

### Example 6

An optical fiber having an outer diameter of 260 μm was produced by forming a primary resin layer used in Example 1 around a glass fiber composed of a core and a cladding and having a diameter of 125 μm so that the primary resin layer had an outer diameter of 190 μm, forming a colored secondary resin layer around the primary resin layer so that the colored secondary resin layer had an outer diameter of 260 μm.

### Example 7

An optical fiber having an outer diameter of 200 μm was produced by forming a primary resin layer used in Example 1 around a glass fiber composed of a core and a cladding and having a diameter of 125 μm so that the primary resin layer had an outer diameter of 170 μm, forming a colored secondary resin layer around the primary resin layer so that the colored secondary resin layer had an outer diameter of 200 μm.

[Optical Fiber Ribbon]

Four optical fibers were placed parallel, coated with a resin composition for a ribbon material, and integrated to obtain an optical fiber ribbon.

[Evaluation]

### (Elastic Modulus)

First, a coating resin layer was peeled from a glass fiber by immersing an optical fiber in MEK. Subsequently, after keeping the peeled coating resin layer under conditions of 25° C. and 50%RH for 12 hours or more, the elastic modulus at a frequency of 11 Hz and a temperature of 85° C. was measured by using a rheometer (solid S analyzer RSA-II). Results are shown in Table 1.

(Adhesion)

First, a cut was made in the coating resin layer of an optical fiber with a razor to a depth at which the edge of the razor does not reach a glass fiber surface, the coating resin layer on the one side of the cut was stuck on a pasteboard, and the pasteboard was fixed and placed in a thermostatic oven at 85° C. Subsequently, the optical fiber on the other side was grasped and pulled at a rate of 5 mm/min, and the pull-out force (maximum) applied when a glass fiber was drawn out of the coating resin layer fixed on the pasteboard was measured, and this was defined as adhesion. Results are shown in Table 1.

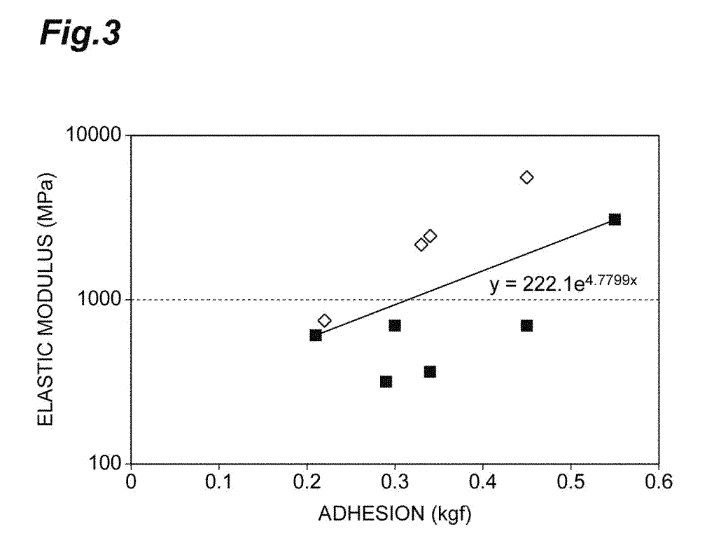

A graph on which the relationships between the adhesion between glass fibers and coating resin layers, and the elastic modulus of coating resin layers in the optical fibers produced in Examples and Comparative Examples are plotted is shown in FIG. 3.

(Simultaneous Ribbon Stripability)

The simultaneous ribbon stripability from an optical fiber ribbon was evaluated by using a product of the trade name “JR-6” manufactured by Sumitomo Electric Industries, Ltd. An optical fiber ribbon was inserted between heaters at 85° C. and kept for five seconds, and thereafter, a ribbon material was stripped together with a coating resin layer. When the form of the coating resin layer was retained and coating leavings did not remain on a glass fiber, the stripability was defined as “good.” Otherwise, the stripability was defined as “inferior.” Results are shown in Table 1 and 2.

TABLE 1

| | Adhesion | Elastic modulus | |
|---|---|---|---|
| | (kgf) | (MPa) | Stripability |
| Example 1 | 0.33 | 2161 | Good |
| Example 2 | 0.45 | 5547 | Good |
| Example 3 | 0.34 | 2438 | Good |
| Example 4 | 0.22 | 747 | Good |
| Comparative | 0.55 | 3078 | Inferior |
| Example 1 | | | |
| Comparative | 0.45 | 694 | Inferior |
| Example 2 | | | |
| Comparative | 0.21 | 606 | Inferior |
| Example 3 | | | |
| Comparative | 0.34 | 364 | Inferior |
| Example 4 | | | |
| Comparative | 0.30 | 606 | Inferior |
| Example 5 | | | |
| Comparative | 0.29 | 317 | Inferior |
| Example 6 | | | |

TABLE 2

| | Outer diameter | Outermost layer | |
|---|---|---|---|
| | (μm) | of optical fiber | Stripability |
| Example 1 | 260 | Ink layer | Good |
| Example 5 | 200 | Ink layer | Good |
| Example 6 | 260 | Colored | Good |
| | | secondary layer | |
| Example 7 | 200 | Colored | Good |
| | | secondary layer | |

It can be confirmed by FIG. 3 as well as Tables 1 and 2 that the optical fibers of Examples 1 to 7 satisfying the relationship represented by the formula (I) have excellent simultaneous ribbon stripability.

### REFERENCE SIGNS LIST

1: optical fiber, 10: glass fiber, 12: core, 14 : cladding, 20: coating resin layer, 22: primary resin layer, 24: secondary resin layer 40: ribbon material, 100: optical fiber ribbon.

1. An optical fiber comprising a glass fiber having a core and a cladding covering the core, and a coating resin layer covering the glass fiber, wherein
when the adhesion between the glass fiber and the coating resin layer at 85° C. is defined as x and the elastic modulus of the coating resin layer at 85° C. and at a frequency of 11 Hz is defined as y, the x is 0.2 to 0.6 kgf, the y is 600 to 6000 MPa, and the x and the y satisfy a relationship represented by the following formula (I):
y>222.1e^{4.7799x} (I).

2. The optical fiber according to claim 1, wherein the outer diameter of the optical fiber is 190 to 260 μm.

3. The optical fiber according to claim 1, wherein the outer diameter of the optical fiber is 190 to 210 μm.

4. The optical fiber according to claim 1, wherein
the outer diameter of the optical fiber is 260 μm or less, and
the coating resin layer is composed of a plurality of layers, and the outermost layer of the coating resin layer is a colored layer.

5. The optical fiber according to claim 1, wherein
the outer diameter of the optical fiber is 210 μm or less, and
the coating resin layer is composed of a plurality of layers, and the outermost layer of the coating resin layer is a colored layer.

6. The optical fiber according to claim 1, wherein
the coating resin layer has a primary resin layer and a secondary resin layer, and
the primary resin layer comprises a cured product of an ultraviolet curable resin composition comprising a polyfunctional monomer.

7. The optical fiber according to claim 6, wherein the ultraviolet curable resin composition further contains a silane coupling agent.

8. An optical fiber ribbon comprising a plurality of the optical fibers according to claim 1 placed parallel and covered with a ribbon material.

9. The optical fiber ribbon according to claim 8, wherein the glass transition temperature of the ribbon material is 60° C. or more.
